(19) United States
(12) Patent Application Publication
(10) Pub. No.: US 2022/0002582 A1
(43) Pub. Date: Jan. 6, 2022

(54) MIXED LIQUID AGENT, POLYURETHANE COMPOSITION, POLYURETHANE FOAM, SPRAY CAN, AND MIXING SYSTEM

(71) Applicant: SEKISUI CHEMICAL CO., LTD., Osaka (JP)

(72) Inventors: Shunji OHARA, Ageo-shi, Saitama (JP); Yuu KAKIMOTO, Kita-ku, Tokyo (JP); Tomonori KAJITA, Atsugi-shi, Kanagawa (JP); Akitsu HIRONO, Hasuda-shi, Saitama (JP)

(73) Assignee: SEKISUI CHEMICAL CO., LTD., Osaka (JP)

(21) Appl. No.: 17/278,431

(22) PCT Filed: Sep. 25, 2019
(86) PCT No.: PCT/JP2019/037550

§ 371 Date: Mar. 22, 2021

(30) Foreign Application Priority Data
Sep. 25, 2018 (JP) 2018-179069

(51) Int. Cl. C09D 175/06; C09D 5/02; C09D 5/18; C09D 7/20; C08G 18/76; C08G 18/42; C08G 18/18; C08J 9/14; C08J 9/00; C08K 13/02

(52) U.S. Cl. CPC C09D 175/06; C08K 2003/026; C09D 5/18; C09D 7/20; C08G 18/7671; C08G 18/42; C08G 18/1875; C08J 9/149; C08J 9/142; C08J 9/141; C08J 9/146; C08J 9/0066; C08J 9/0038; C08K 13/02; C08J 2201/022; C08J 2207/04; C08J 2203/182; C08J 2203/12; C08J 2203/14; C08J 2203/162; C08J 2375/06; C09D 5/021

(57) ABSTRACT

A mixed liquid agent of the present invention comprises a polyol compound, a catalyst, a flame retardant, and an organic solvent. The flame retardant includes a solid flame retardant. The organic solvent has a vapor pressure at 20° C. of 0.1 MPaG or more. A viscosity at 1 rpm and 25° C. after the organic solvent has been volatilized is 4,000 mPa·s or more and less than 250,000 mPa·s.

### TECHNICAL FIELD

The present invention relates to a mixed liquid agent comprising a polyol compound, a polyurethane composition comprising the mixed liquid agent and an isocyanate liquid agent, a polyurethane foam formed from the polyurethane composition, a spray can in which the mixed liquid agent is enclosed, and a mixing system for mixing the mixed liquid agent with an isocyanate liquid agent.

### BACKGROUND ART

Conventionally, a polyurethane foam has been used as a thermal insulator for vehicles such as automobiles, railroad carriages, and ships, as well as for buildings. As the polyurethane foam, a two-component polyurethane in which a polyol liquid agent and an isocyanate liquid agent filled in different containers are mixed to form a foam is widely used.

Two-component polyurethane is sometimes used for an aerosol because each liquid can be discharged and mixed from the containers using a relatively simple structure. When two-component polyurethane is used for an aerosol, one container is filled with polyisocyanate and a low boiling point organic solvent, and the other container is filled with a polyol and a low boiling point organic solvent. An isocyanate liquid agent and a polyol liquid agent are discharged from each container by the vapor pressure of the low boiling point solvents, and are mixed to form a polyurethane foam.

A hydrofluorocarbon (HFC), a hydrochlorofluorocarbon (HCFC), dimethyl ether, liquefied petroleum gas, and the like are used as the low boiling point solvent used for the two-component polyurethane aerosol. Further, since HFCs and HCFCs have a high global warming potential, the use of hydrofluoroolefins (HFOs) having a low global warming potential is also being considered in place of HFCs and HCFCs.

Further, in polyurethane foam, a flame retardant may be used for the purpose of imparting a flame retardancy performance. In a two-component polyurethane aerosol, for example, a flame retardant is blended with a polyol, and as such a flame retardant, as disclosed in Patent Literature 1, a liquid phosphoric acid ester compound such as tris(β-chloropropyl)phosphate is used.

### CITATION LIST

### Patent Literature

PTL1: JP 11-49837 A

### SUMMARY OF INVENTION

### Technical Problem

However, in the case of a two-component polyurethane aerosol, it is necessary to increase the discharge flow rate when discharging the polyol liquid agent and the isocyanate liquid agent from each container. This is because if the discharge flow rate is insufficient, the polyol liquid agent and the isocyanate liquid agent do not sufficiently mix, the polyurethane foam is not properly formed, and various properties such as flame retardancy are poor.

Further, in recent years, due to heightened awareness of disaster prevention, the polyurethane foam used as a thermal insulator may be required to have high flame retardancy performance, and the use of a flame retardant with a high flame retardant effect is being considered. However, many flame retardants having a high flame retardant effect are in a solid state, and when mixed with a polyol, for example, the fluidity of the polyol is reduced. Therefore, the discharge flow rate of the polyol liquid agent becomes insufficient in the aerosol, and problems such as the polyol liquid agent not sufficiently mixing with the isocyanate liquid agent occur, and in the end, the flame retardancy cannot be sufficiently increased.

Therefore, an object of the present invention is to provide a mixed liquid agent capable of forming a polyurethane foam having a high flame retardancy even when applied to an aerosol, for example.

### Solution to Problem

As a result of diligent studies, the present inventors have found that the above-described problem can be solved by, in a mixed liquid agent containing a polyol compound, using an organic solvent having a certain vapor pressure and a solid flame retardant in combination, to thereby complete the following inventions. That is, the present invention provides the following [1] to [15].
[1] A mixed liquid agent comprising a polyol compound, a catalyst, a flame retardant, and an organic solvent,

the flame retardant including a solid flame retardant,

the organic solvent having a vapor pressure at 20° C. of 0.1 MPaG or more,

a viscosity of the mixed liquid agent at 1 rpm and 25° C. after the organic solvent has been volatilized being 4,000 mPa·s or more and less than 250,000 mPa·s.
[2] The mixed liquid agent according to [1], wherein the viscosity is 10,000 mPa·s or more.
[3] The mixed liquid agent according to [1] or [2], wherein the solid flame retardant is at least one selected from the group consisting of a red phosphorus flame retardant, a phosphoric acid salt-containing flame retardant, a bromine-containing flame retardant, a chlorine-containing flame retardant, an antimony-containing flame retardant, a boron-containing flame retardant, and a metal hydroxide.
[4] The mixed liquid agent according to any one of [1] to [3], wherein a solid content concentration after the organic solvent has been volatilized is 15 to 40% by mass.
[5] The mixed liquid agent according to any one of [1] to [4], wherein the flame retardant further includes a liquid flame retardant.
[6] The mixed liquid agent according to any one of [1] to [5], wherein the organic solvent includes at least one selected from the group consisting of a hydrocarbon having 2 to 5 carbon atoms and dimethyl ether.
[7] The mixed liquid agent according to any one of [1] to [6], wherein the mixed liquid agent further comprises a foam stabilizing agent.
[8] The mixed liquid agent according to any one of [1] to [7], wherein the mixed liquid agent is used for an aerosol.
[9] A spray can in which the mixed liquid agent according to any one of [1] to [8] is enclosed.
[10] A polyurethane composition comprising the mixed liquid agent according to any one of [1] to [8] and an isocyanate liquid agent containing a polyisocyanate.
[11] The polyurethane composition according to [10], wherein the polyurethane composition has an isocyanate index of 250 to 1000.
[12] A polyurethane foam formed from the polyurethane composition according to [10] or [11].
[13] The polyurethane foam according to [12], wherein the polyurethane foam is used as a thermal insulator for a vehicle or a building.
[14] A mixing system comprising a first container in which the mixed liquid agent according to any one of [1] to [8] is enclosed and a second container in which an isocyanate liquid agent containing a polyisocyanate is enclosed,

the first and second containers being both spray cans,

the mixing system being configured to mix the mixed liquid agent discharged from the first container and the isocyanate liquid agent discharged from the second container.
[15] The mixing system according to [14], comprising a stationary mixer being configured to mix the mixed liquid agent discharged from the first container and the isocyanate liquid agent discharged from the second container.

### Advantageous Effects of Invention

The present invention provides a mixed liquid agent capable of forming, even when applied to an aerosol, for example, a polyurethane foam having a high flame retardancy.

### BRIEF EXPLANATION OF DRAWINGS

FIG. 1 is a schematic view illustrating an embodiment of a mixing system of the present invention.

### DESCRIPTION OF EMBODIMENTS

The present invention will now be described in detail with reference to embodiments.

### [Mixed Liquid Agent]

The mixed liquid agent of the present invention comprises a polyol compound, a catalyst, a flame retardant, and an organic solvent. The flame retardant includes a solid flame retardant, and the organic solvent has a vapor pressure at 20° C. of 0.1 MPaG or more.

In the present invention, even when a solid flame retardant is used as the flame retardant, by using an organic solvent having a vapor pressure of a certain level or higher, the mixed liquid agent can be discharged at a high discharge flow rate by the vapor pressure of the organic solvent. Therefore, the miscibility between the mixed liquid agent (that is, the polyol liquid agent) and the isocyanate liquid agent can be increased, and a polyurethane foam having various good properties such as flame retardancy can be formed. In addition, the use of solid flame retardant increases the flame retardancy of the polyurethane foam. Therefore, in the present invention, a polyurethane foam having excellent flame retardancy can be formed.

### (Viscosity of Mixed Liquid Agent)

In the present invention, the viscosity of the mixed liquid agent after the organic solvent has been volatilized is adjusted within a certain range in order to increase the flame retardancy. Specifically, the viscosity of the mixed liquid agent after the organic solvent has been volatilized is 4,000 mPa·s or more and less than 250,000 mPa·s. This viscosity is obtained by measuring the viscosity of a mixed liquid agent after the organic solvent has been volatilized with a B-type viscometer under the conditions of 1 rpm and 25° C.

In the present invention, if the viscosity is 250,000 mPa·s or more, it becomes difficult for the mixed liquid agent to secure a constant fluidity at the time of discharge. As a result, the discharge flow rate decreases, the miscibility with the isocyanate solvent deteriorates, the polyol compound may not appropriately react with the polyisocyanate, and it is difficult to form a polyurethane foam having various excellent properties such as flame retardancy. From the viewpoint of increasing the miscibility and obtaining excellent flame retardancy and the like, the viscosity is preferably 200,000 mPa·s or less, more preferably 150,000 mPa·s or less, and further preferably 120,000 mPa·s or less.

Further, if the viscosity is less than 4,000 mPa·s, it becomes difficult to mix a certain amount or more of a solid flame retardant in the mixed liquid agent, and it becomes difficult to increase the flame retardancy. Moreover, if the viscosity is low, such as less than 4,000 mPa·s, the solid flame retardant tends to precipitate. From the viewpoint of increasing the flame retardancy and preventing the solid flame retardant from precipitating, the viscosity is more preferably 10,000 mPa·s or more, further preferably 40,000 mPa·s or more, and particularly preferably 70,000 mPa·s or more.

### (Solid Content Concentration of Mixed Liquid Agent)

The mixed liquid agent of the present invention preferably has a solid content concentration of 15 to 40% by mass after the organic solvent is volatilized. Here, the solid content is the component that remains after the organic solvent is volatilized and the mixed liquid agent is removed by filtering, and refers to the insoluble matter that is not dissolved in the mixed liquid agent. Details of the method for measuring the solid content concentration are as described in the Examples.

In the present invention, even when a certain amount of insoluble matter is included in the mixed liquid agent, the mixed liquid agent can be discharged at a high discharge flow rate by using an organic solvent having a vapor pressure of a certain value or more and setting the viscosity of the mixed liquid agent preferably after the organic solvent has been volatilized to within the above range.

By setting the solid content concentration to 15% by mass or more, a certain amount or more of the flame-retardant component is easily blended in the mixed liquid agent, and it is easier to improve the flame retardancy of the obtained polyurethane foam. From the viewpoint of obtaining even better flame retardancy, the solid content concentration is more preferably 17% by mass or more, further preferably 20% by mass or more, and particularly preferably 25% by mass or more.

On the other hand, by setting the solid content concentration to 40% by mass or less, the mixed liquid agent can be discharged at a high discharge flow rate, the miscibility with the isocyanate liquid agent is increased, and as a result the polyurethane foam has excellent various properties such as flame retardancy. From the viewpoint of improving the miscibility and further increasing the flame retardancy and the like, the solid content concentration is more preferably 35% by mass or less, and further preferably 32% by mass or less.

Hereinafter, each component used in the mixed liquid agent of the present invention will be described in more detail.

### (Organic Solvent)

The organic solvent contained in the mixed liquid agent causes the mixed liquid agent to discharge as a result of the vapor pressure of the organic solvent, and also causes the mixed liquid agent and a polyurethane composition described later to foam by vaporizing when the mixed liquid agent is discharged. In the present invention, the organic solvent contained in the mixed liquid agent has a vapor pressure of 0.1 MPaG or more at 20° C. If the vapor pressure is less than 0.1 MPaG, the vapor pressure is insufficient, it is difficult to discharge the mixed liquid agent containing a solid flame retardant at a high discharge flow rate, and it is impossible to appropriately mix with the isocyanate liquid agent after the mixed liquid agent is discharged. In addition, foaming may be insufficient when discharging.

The organic solvent has a vapor pressure at 20° C. of preferably 0.2 MPaG or more, and more preferably 0.3 MPaG or more. By setting the vapor pressure to be not less than these lower limit values, the discharge flow rate is high and the miscibility with the isocyanate liquid agent is excellent. Further, the foaming property when forming the polyurethane foam is also excellent.

The upper limit values of the vapor pressure at 20° C. is not particularly limited, and is, for example, 10 MPaG. Further, to prevent the internal pressure inside the spray can from becoming too high, the vapor pressure at 20° C. is preferably 3 MPaG or less, and more preferably 1 MPaG or less.

One kind of the organic solvent may be used alone, or two or more kinds of the organic solvent may be used in combination. When two or more kinds are used in combination, the “vapor pressure at 20° C.” means the vapor pressure at 20° C. of the mixture of the two or more kinds of organic solvents (mixed solvent). Therefore, when two or more kinds are used in combination, an organic solvent having a vapor pressure of 0.1 MPaG or more at 20° C. and an organic solvent having a vapor pressure of less than 0.1 MPaG at 20° C. may be used in combination.

The organic solvent used in the present invention is preferably selected from a hydrocarbon having 2 to 5 carbon atoms and dimethyl ether. These organic solvents have a relatively high vapor pressure and also have good compatibility with polyol compounds. Examples of the hydrocarbon having 2 to 5 carbon atoms include ethane, propane, various butanes such as isobutane and normal butane, and various pentanes such as isopentane, normal pentane, and cyclopentane.

The above-described hydrocarbons and dimethyl ether may be used singly or in combination of two or more thereof. For example, LPG containing propane and butane as main components may be mentioned as suitable specific example.

Further, as the hydrocarbon and dimethyl ether, among the above, a hydrocarbon having 3 or 4 carbon atoms such as propane, isobutane, and normal butane, and dimethyl ether are preferable in order to keep the vapor pressure in a suitable range. In addition, from the viewpoint of compatibility and the like, dimethyl ether or a mixed solvent of dimethyl ether and propane, isobutane, or normal butane is more preferable.

As described above, the organic solvent preferably contains at least one selected from the above-described hydrocarbons and dimethyl ether. In that case, another organic solvent other than these may be contained or may not be contained. Examples of another organic solvent include a hydrofluoroolefin.

Examples of the hydrofluoroolefin include fluoroalkenes having 3 to 6 carbon atoms. Further, the hydrofluoroolefin may be a hydrochlorofluoroolefin having a chlorine atom, and therefore may be a chlorofluoroalkene or the like having 3 to 6 carbon atoms. The hydrofluoroolefin preferably has 3 or 4 carbon atoms, and more preferably 3 carbon atoms.

More specifically, examples include trifluoropropene, a tetrafluoropropene such as HFO-1234, a pentafluoropropene such as HFO-1225, a chlorotrifluoropropene such as HFO-1233, chlorodifluoropropene, chlorotrifluoropropene, chlorotetrafluoropropene, and the like. More specifically, examples include 1,3,3,3-tetrafluoropropene (HFO-1234ze), 1,1,3,3-tetrafluoropropene, 1,2,3,3,3-pentafluoropropene (HFO-1225ye), 1,1,1-trifluoropropene, 1,1,1,3,3-pentafluoropropene (HFO-1225zc), 1,1,1,3,3,3-hexafluorobut-2-ene, 1,1,2,3,3-pentafluoropropene (HFO-1225yc), 1,1,1,2,3-pentafluoropropene (HFO-1225yez), 1-chloro-3,3,3-trifluoropropene (HFO-1233zd), 1,1,1,4,4,4-hexafluorobut-2-ene, and the like. Of these, HFO-1233zd is preferable.

These hydrofluoroolefins may be used singly or in combination of two or more thereof.

The hydrofluoroolefin may be used in combination with one or more selected from a hydrocarbon and dimethyl ether so that the vapor pressure of the organic solvent is within the above-described range.

The amount of the organic solvent blended in the mixed liquid agent is not particularly limited, and is preferably 10 to 150 parts by mass, more preferably 15 to 70 parts by mass, and further preferably 20 to 50 parts by mass, with respect to 100 parts by mass of the polyol compound. By setting the amount of the organic solvent blended to within these ranges, it is easier to achieve a good discharge flow rate and foaming property. Further, by setting the amount blended to be not more than the upper limit values, it is possible to prevent the amount of the organic solvent blended in the mixed liquid agent from being more than is necessary.

### (Polyol Compound)

The mixed liquid agent of the present invention contains a polyol compound as a raw material of the polyurethane foam. Examples of the polyol compound include a polylactone polyol, a polycarbonate polyol, an aromatic polyol, an alicyclic polyol, an aliphatic polyol, a polyester polyol, a polymer polyol, a polyether polyol, and the like. The polyol compound usually turns into a liquid at normal temperature (23° C.) and normal pressure (1 atm).

Examples of the polylactone polyol include polypropiolactone glycol, polycaprolactone glycol, polyvalerolactone glycol, and the like.

Examples of the polycarbonate polyol include a polyol obtained by a dealcohol reaction between a hydroxyl group-containing compound, such as ethylene glycol, propylene glycol, butanediol, pentanediol, hexanediol, octanediol, and nonanediol, and ethylene carbonate, propylene carbonate, and the like.

Examples of the aromatic polyol include bisphenol A, bisphenol F, phenol novolac, cresol novolac, and the like.

Examples of the alicyclic polyol include cyclohexanediol, methylcyclohexanediol, isophoronediol, dicyclohexylmethanediol, dimethyldicyclohexylmethanediol, and the like.

Examples of the aliphatic polyol include an alkanediol such as ethylene glycol, propylene glycol, butanediol, pentanediol, and hexanediol.

Examples of the polyester polyol include a polymer obtained by dehydration condensation of a polybasic acid and a polyhydric alcohol, a polymer obtained by ring-opening polymerization of a lactone such as c-caprolactone and a-methyl-c-caprolactone, and a condensate of hydroxycarboxylic acid and the polyhydric alcohol or the like.

Examples of the polybasic acid include adipic acid, azelaic acid, sebacic acid, isophthalic acid (m-phthalic acid), terephthalic acid (p-phthalic acid), succinic acid, and the like. Further, examples of the polyhydric alcohol include bisphenol A, ethylene glycol, 1,2-propylene glycol, 1,4-butanediol, diethylene glycol, 1,6-hexane glycol, neopentyl glycol, and the like.

Examples of the hydroxycarboxylic acid include castor oil, a reaction product of castor oil and ethylene glycol, and the like.

Examples of the polymer polyol include a polymer obtained by graft-polymerizing an ethylenically unsaturated compound such as acrylonitrile, styrene, methyl acrylate, and methacrylate with an aromatic polyol, an alicyclic polyol, an aliphatic polyol, a polyester polyol, or the like, a polybutadiene polyol, a modified polyol of a polyhydric alcohol, a hydrogenated additive thereof, and the like.

Examples of the modified polyol of a polyhydric alcohol include a polyol modified by reacting the raw material polyhydric alcohol with an alkylene oxide, and the like.

Examples of the polyhydric alcohol include a trihydric alcohol such as glycerin and trimethylolpropane, tetra to octavalent alcohols such as pentaerythritol, sorbitol, mannitol, sorbitan, diglycerin, dipentaerythritol and the like, sucrose, glucose, mannose, fructose, methylglucoside, derivatives of these, and the like, polyols such as fluoroglucolcinol, cresol, pyrogallol, catechol, hydroquinone, bisphenol A, bisphenol F, bisphenol S, 1,3,6,8-tetrahydroxynaphthalene, and 1,4,5,8-tetrahydroxyanthracene, polyfunctional (for example, 2 to 100 functional groups) polyols such as castor oil polyol, a (co)polymer of hydroxyalkyl (meth)acrylate and a polyvinyl alcohol, a condensate of a phenol and formaldehyde (Novolak), and the like.

The method for modifying the polyhydric alcohol is not particularly limited, and a method for adding an alkylene oxide (hereinafter, also referred to as “AO”) can be preferably used. Examples of the AO include an AO having 2 to 6 carbon atoms, for example, ethylene oxide (hereinafter, also referred to as “EO”), 1,2-propylene oxide (hereinafter, also referred to as “PO”), 1,3-propyleneoxide, 1,2-butylene oxide, 1,4-butylene oxide, and the like.

Among these, PO, from the viewpoint of properties and reactivity, EO and 1,2-butylene oxide are preferable, and PO and EO are more preferable. When two or more kinds of AO are used (for example, PO and EO), the addition method may be block addition, random addition, or a combination of these.

Examples of the polyether polyol include a polymer obtained by subjecting at least one kind of alkylene oxide, such as ethylene oxide, propylene oxide, and tetrahydrofuran, to ring-opening polymerization in the presence of at least one kind of low-molecular-weight active hydrogen compound having two or more active hydrogens and the like. Examples of the low-molecular-weight active hydrogen compound having two or more active hydrogens include a diol such as bisphenol A, ethylene glycol, propylene glycol, butylene glycol, and 1,6-hexanediol, a triol such as glycerin and trimethylolpropane, an amine such as ethylenediamine and butylene diamine, and the like.

As the polyol compound used in the present invention, a polyester polyol and a polyether polyol are preferable. Among them, an aromatic polyester polyol obtained by dehydration condensation of a polybasic acid having an aromatic ring, such as isophthalic acid (m-phthalic acid) and terephthalic acid (p-phthalic acid), and a dihydric alcohol, such as bisphenol A, ethylene glycol, and 1,2-propylene glycol, is more preferable. Further, a polyol having two hydroxyl groups is preferable.

### (Catalyst)

The mixed liquid agent of the present invention may contain as the catalyst, for example, a trimerization catalyst, a resinification catalyst, or both, but it is preferable to contain both.

The trimerization catalyst is a catalyst that promotes the formation of an isocyanurate rings by causing the isocyanate groups included in the polyisocyanate to react and trimerize. Examples of trimerization catalysts that can be used include a nitrogen-containing aromatic compound such as tris(dimethylaminomethyl)phenol, 2,4-bis(dimethylaminomethyl)phenol, and 2,4,6-tris(dialkylaminoalkyl)hexahydro-S-triazine, a carboxylic acid alkali metal salt such as potassium acetate, potassium 2-ethylhexanoate, and potassium octylate, a tertiary ammonium salt such as a trimethylammonium salt, a triethylammonium salt, and a triphenylammonium salt, a quaternary ammonium salt such as a tetramethylammonium salt, a tetraethylammonium salt, a tetraphenylammonium salt, and a triethylmonomethylammonium salt, and the like. Examples of the ammonium salt include an ammonium salt of a carboxylic acid such as 2,2-dimethylpropanoic acid, and more specifically a quaternary ammonium salt of a carboxylic acid.

These may be used alone or in combination of two or more. Among these, one or more selected from a carboxylic acid alkali metal salt and a carboxylic acid quaternary ammonium salt are preferable, and a mode in which both of them are used is also preferable.

The amount of the trimerization catalyst blended is preferably 1 to 25 parts by mass, more preferably 2 to 18 parts by mass, and further preferably 3 to 15 parts by mass, with respect to 100 parts by mass of the polyol compound. When the amount of the trimerization catalyst blended is equal to or more than these lower limit values, trimerization of polyisocyanate occurs more easily, and the flame retardancy of the obtained polyurethane foam is improved. On the other hand, when the amount of the trimerization catalyst blended is equal to or less than these upper limit values, the reaction is controlled more easily.

The resinification catalyst is a catalyst that catalyzes the reaction between the polyol compound and the polyisocyanate. Examples of the resinification catalyst include an amine-based catalyst such as an imidazole compound and a piperazine compound, a metal-based catalyst, and the like.

Examples of the imidazole compound include a tertiary amine in which the secondary amine at the 1-position of the imidazole ring is replaced with an alkyl group, an alkenyl group, or the like. Specific examples include N-methylimidazole, 1,2-dimethylimidazole, 1-ethyl-2-methylimidazole, 1-methyl-2-ethylimidazole, 1,2-diethylimidazole, 1isobutyl-2-methylimidazole, and the like. Further, an imidazole compound in which the secondary amine in the imidazole ring is replaced with a cyanoethyl group may be used.

In addition, examples of the piperazine compound include a tertiary amine such as N-methyl-N′N′-dimethylaminoethylpiperazine and trimethylaminoethylpiperazine.

Further, in addition to the imidazole compound and the piperazine compound, examples of the resinification catalyst include various tertiary amines such as pentamethyldiethylenetriamine, triethylamine, N-methylmorpholinbis(2-dimethylaminoethyl)ether, N,N,N′,N″,N″-pentamethyldiethylenetriamine, N,N,N′-trimethylaminoethyl-ethanolamine, bis(2-dimethylaminoethyl)ether, N,N-dimethylcyclohexylamine, diazabicycloundecene, triethylenediamine, tetramethylhexamethylenediamine, tripropylamine, and the like.

Examples of the metal-based catalyst include a metal salt composed of lead, tin, bismuth, copper, zinc, cobalt, nickel, and the like, and preferably an organic acid metal salt composed of lead, tin, bismuth, copper, zinc, cobalt, nickel and the like. More preferably, examples include dibutyltin dilaurate, dioctyltin dilaurate, dioctyltin versatate, bismuth trioctate, bismuth tris(2-ethylhexanoate), tin dioctylate, lead dioctylate, and the like. Among them, an organic acid bismuth salt is more preferable.

The resinification catalyst may be used alone or in combination of two or more. Further, among the above, it is preferable to use one or more selected from the imidazole compound and the organic acid bismuth salt, and a mode in which both of them are used is also preferable.

The amount of the resinification catalyst blended is preferably 1 to 25 parts by mass, more preferably 2 to 18 parts by mass, and even more preferably 3 to 12 parts by mass, with respect to 100 parts by mass of the polyol compound. When the amount of the resinification catalyst blended is equal to or more than these lower limit values, a urethane bond tends to form, and the reaction proceeds rapidly. On the other hand, when the amount blended is equal to or less than these upper limit values, the reaction rate is controlled more easily.

The total amount of the catalyst in the mixed liquid agent is not particularly limited, and is preferably 2 to 40 parts by mass, more preferably 4 to 25 parts by mass, and further preferably 5 to 20 parts by mass. When the total amount is equal to or more than these lower limit values, the formation of urethane bonds and the trimerization proceed appropriately, and the flame retardancy tends to be good. Further, when the total amount is equal to or less than these upper limit values, the urethanization and trimerization reactions are controlled more easily.

### (Solid Flame Retardant)

The mixed liquid agent of the present invention includes a flame retardant, and the flame retardant includes a solid flame retardant. In the present invention, flame retardancy can be increased more effectively by using a solid flame retardant. Further, usually, the solid flame retardant is in a dispersed state as a powder component in the mixed liquid agent, and constitutes at least a part of the above-described solid content (insoluble matter). The solid flame retardant is a flame retardant that is a solid at normal temperature (23° C.) and normal pressure (1 atm).

Specific examples of the solid flame retardant include a red phosphorus flame retardant, a phosphoric acid salt-containing flame retardant, a bromine-containing flame retardant, a chlorine-containing flame retardant, an antimony-containing flame retardant, a boron-containing flame retardant, and a metal hydroxide. These may be used alone or in combination of two or more.

### <Red Phosphorus Flame Retardant>

The red phosphorus flame retardant may be composed of red phosphorus alone, but may also be red phosphorus coated with a resin, a metal hydroxide, a metal oxide, or the like, or may be a mixture of red phosphorus with a resin, a metal hydroxide, a metal oxide or the like. The resin that may be coated on red phosphorus or mixed with red phosphorus is not particularly limited, and examples thereof include thermosetting resins such as a phenol resin, an epoxy resin, an unsaturated polyester resin, a melamine resin, a urea resin, an aniline resin, a silicone resin, and the like. As the compound to be coated or mixed, a metal hydroxide is preferable from the viewpoint of flame retardancy. The metal hydroxide may be appropriately selected and used from among those described later.

The amount of the red phosphorus flame retardant blended in the mixed liquid agent is preferably 5 to 40 parts by mass, more preferably 12 to 35 parts by mass, further preferably 15 to 32 parts by mass, and still further preferably 20 to 28 parts by mass, with respect to 100 parts by mass of the polyol compound. By setting the amount of the red phosphorus flame retardant blended to be not less than these lower limit values, the effect gained by containing the red phosphorus flame retardant is more easily exhibited. On the other hand, by setting the amount blended to be not more than these upper limit values, foaming is not inhibited by the red phosphorus flame retardant.

### <Phosphoric Acid Salt-Containing Flame Retardant>

Examples of the phosphoric acid salt-containing flame retardant include a phosphoric acid salt that is composed of a salt of various phosphoric acids with at least one metal or compound selected from, metals of Group IA to IVB of the Periodic Table, ammonia, an aliphatic amine, an aromatic amine, and a heterocyclic compound including nitrogen in the ring.

The phosphoric acid is not particularly limited, and examples thereof include a monophosphoric acid, a pyrophosphoric acid, a polyphosphoric acid, and the like.

Examples of the metals of Group IA to IVB of the Periodic Table include lithium, sodium, calcium, barium, iron(II), iron(III), and aluminum.

Examples of the aliphatic amine include methylamine, ethylamine, diethylamine, triethylamine, ethylenediamine, piperazine, and the like. Examples of the aromatic amine include aniline, o-toluidine, 2,4,6-trimethylaniline, anisidine, 3-trifluoromethyl)aniline, and the like. Examples of the heterocyclic compound containing nitrogen in the ring include pyridine, triazine, melamine, and the like.

Specific examples of the phosphoric acid salt-containing flame retardant include a monophosphoric acid salt, a pyrophosphoric acid salt, a polyphosphoric acid salt, and the like. Here, the polyphosphoric acid salt is not particularly limited, and examples thereof include ammonium polyphosphate, piperazine polyphosphate, melamine polyphosphate, ammonium amide polyphosphate, and aluminum polyphosphate.

One or more kinds of the above-described phosphoric acid salt-containing flame retardant can be used.

The amount of the phosphoric acid salt-containing flame retardant blended in the mixed liquid agent is not particularly limited, and is 3 to 40 parts by mass, more preferably 5 to 35 parts by mass, and further preferably 10 to 30 parts by mass, with respect to 100 parts by mass of the polyol compound. By setting the amount of the phosphoric acid salt-containing flame retardant blended to be not less than these lower limit values, the effect gained by containing the phosphoric acid salt-containing flame retardant is exhibited more easily. On the other hand, by setting the amount blended to be not more than these upper limit values, foaming is not inhibited by the phosphoric acid salt-containing flame retardant.

### <Bromine-Containing Flame Retardant>

The bromine-containing flame retardant is not particularly limited as long as it is a compound that contains bromine in its molecular structure and that is a solid at normal temperature and pressure. Examples thereof include a brominated aromatic ring-containing aromatic compound and the like.

Examples of the brominated aromatic ring-containing aromatic compound include monomer-based organic bromine compounds such as hexabromobenzene, pentabromotoluene, hexabromobiphenyl, decabromobiphenyl, decabromodiphenyl ether, octabromodiphenyl ether, hexabromodiphenyl ether, bis(pentabromophenoxy)ethane, ethylenebis(pentabromophenoxy), ethylenebis(tetrabromophthalimide), tetrabromobisphenol A, and the like.

Further, the brominated aromatic ring-containing aromatic compound may be a bromine compound polymer. Specifically, examples include a polycarbonate oligomer produced from brominated bisphenol A as a raw material, a brominated polycarbonate of a copolymer and the like of this polycarbonate oligomer and bisphenol A, a diepoxy compound produced by a reaction between brominated bisphenol A and epichlorohydrin, and the like. Further examples include a brominated epoxy compound such as a monoepoxy compound obtained by a reaction between a brominated phenol and epichlorohydrin, poly(brominated benzyl acrylate), a condensate of a brominated polyphenylene ether, a brominated bisphenol A, and a brominated phenol of cyanuric chloride, a brominated(polystyrene), a poly(brominated styrene), a brominated polystyrene such as a crosslinked brominated polystyrene, a crosslinked or non-crosslinked brominated poly(-methylstyrene), and the like.

Further, the bromine-containing flame retardant may be a compound other than a brominated aromatic ring-containing aromatic compound, such as hexabromocyclododecane.

These bromine-containing flame retardants may be used singly or in combination of two or more thereof.

Further, among the above, a brominated aromatic ring-containing aromatic compound is preferable, and among them, a monomer-based organic bromine compound such as ethylene bis(pentabromophenyl) is preferable.

The amount of the bromine-containing flame retardant blended in the mixed liquid agent is preferably 3 to 45 parts by mass, more preferably 14 to 40 parts by mass, further preferably 18 to 38 parts by mass, and still further preferably 23 to 32 parts by mass, with respect to 100 parts by mass of the polyol compound. By setting the amount of the bromine-containing flame retardant blended to be not less than these lower limit values, the effect gained by containing the bromine-containing flame retardant is more easily exhibited. On the other hand, by setting the amount blended to be not more than these upper limit values, foaming is not inhibited by the bromine-containing flame retardant flame retardant.

### <Chlorine-Containing Flame Retardant>

Examples of the chlorine-containing flame retardant include those commonly used in flame retardancy resin compositions, such as polynaphthalene chloride, chlorendic acid, dodecachlorododecahydrodimethanodibenzocyclooctene sold under the trade name of “Dechlorane Plus”, and the like.

The amount of the chlorine-containing flame retardant used in the present invention blended is not particularly limited, and is preferably 3 to 40 parts by mass, more preferably 5 to 35 parts by mass, and further preferably 10 to 30 parts by mass, with respect to 100 parts by mass of the polyol compound. By setting the amount of the chlorine-containing flame retardant blended to be not less than these lower limit values, the effect gained by containing the chlorine-containing flame retardant is more easily exhibited. On the other hand, by setting the amount blended to be not more than these upper limit values, foaming is not inhibited by the chlorine-containing flame retardant.

### <Antimony-Containing Flame Retardant>

Examples of the antimony-containing flame retardant include an antimony oxide, an antimonate, a pyroantimonate, and the like. Examples of antimony oxide include antimony trioxide and antimony pentoxide, and the like. Examples of the antimonate include sodium antimonate, potassium antimonate, and the like. Examples of the pyroantimonate include sodium pyroantimonate, potassium pyroantimonate, and the like.

The antimony-containing flame retardant may be used alone or in combination of two or more.

The antimony-containing flame retardant used in the present invention is preferably an antimony oxide.

The amount of the antimony-containing flame retardant blended in the mixed liquid agent is not particularly limited, and is preferably 1 to 40 parts by mass, more preferably 2 to 35 parts by mass, and further preferably 3 to 30 parts by mass, with respect to 100 parts by mass of the polyol compound. By setting the amount of the antimony-containing flame retardant blended to be not less than these lower limit values, the effect gained by containing the antimony-containing flame retardant is more easily exhibited and flame retardancy is increased. On the other hand, by setting the amount blended to be not more than these upper limit values, foaming is not inhibited by the antimony-containing flame retardant.

### <Boron-Containing Flame Retardant>

Examples of the boron-containing flame retardant used in the present invention include borax, a boron oxide, boric acid, a borate, and the like. Examples of the boron oxide include diboron trioxide, boron trioxide, diboron dioxide, tetraboron trioxide, tetraboron pentoxide, and the like.

Examples of the borate include a borate of an alkali metal, an alkaline earth metal, an element of Groups 4, 12, and 13 of the Periodic Table, and ammonium, and the like. Specifically, examples include an alkali metal borate salt such as lithium borate, sodium borate, potassium borate, and cesium borate, an alkaline earth metal borate salt such as magnesium borate, calcium borate, and barium borate, zirconium borate, zinc borate, aluminum borate, and ammonium borate, and the like.

The boron-containing flame retardant may be used alone or in combination of two or more.

The boron-containing flame retardant used in the present invention is preferably a borate, and more preferably zinc borate.

The amount of the boron-containing flame retardant blended in the mixed liquid agent is not particularly limited, and is preferably 1 to 40 parts by mass, more preferably 3 to 20 parts by mass, further preferably 5 to 15 parts by mass, and still further preferably 7 to 13 parts by mass, with respect to 100 parts by mass of the polyol compound. By setting the amount of the boron-containing flame retardant blended to be not less than these lower limit values, the effect gained by containing the boron-containing flame retardant is more easily exhibited and flame retardancy is increased. On the other hand, by setting the amount blended to be not more than these upper limit values, foaming is not inhibited by the boron-containing flame retardant.

### <Metal Hydroxide>

Examples of the metal hydroxide used in the present invention include magnesium hydroxide, calcium hydroxide, aluminum hydroxide, iron hydroxide, nickel hydroxide, zirconium hydroxide, titanium hydroxide, zinc hydroxide, copper hydroxide, vanadium hydroxide, tin hydroxide, and the like. The metal hydroxide may be used alone or in combination of two or more.

The amount of the metal hydroxide blended in the mixed liquid agent is, for example, 0.1 to 50 parts by mass, preferably 0.2 to 30 parts by mass, further preferably 0.3 to 20 parts by mass, and further preferably 0.5 to 15 parts by mass, with respect to 100 parts by mass of the polyol compound. By setting the amount of the metal hydroxide blended to be not less than these lower limit values, the effect gained by containing the metal hydroxide is more easily exhibited and flame retardancy is increased. On the other hand, by setting the amount blended to be not more than these upper limit values, foaming is not inhibited by the metal hydroxide.

### <Amount of Solid Flame Retardant Blended>

In the present invention, by setting the amount of the solid flame retardant blended in the mixed liquid agent to be not more than a certain amount, and setting the solid content concentration, the viscosity, or both, of the mixed liquid agent to within the desired ranges as described above, the mixed liquid agent can be discharged at a high discharge flow rate, and the miscibility with the isocyanate liquid agent is also improved. From such a viewpoint, the amount of the solid flame retardant blended in the mixed liquid agent may be, for example, 150 parts by mass or less with respect to 100 parts by mass of the polyol compound, but from the viewpoint of having a sufficiently high discharge flow rate as well as excellent miscibility, the amount blended is preferably 90 parts by mass or less, more preferably 85 parts by mass or less, and further preferably 75 parts by mass or less.

On the other hand, by setting the amount of the solid flame retardant blended in the mixed liquid agent to be not less than a certain amount, the solid flame retardant can impart an appropriate flame retardancy to the polyurethane foam. From such a viewpoint, the amount of the solid flame retardant blended is, for example, 20 parts by mass or more with respect to 100 parts by mass of the polyol compound, but in order to sufficiently increase the flame retardancy by the solid flame retardant, the amount blended is preferably 30 parts by mass or more, more preferably 45 parts by mass or more, further preferably 55 parts by mass or more, and most preferably 60 parts by mass or more.

### (Liquid Flame Retardant)

The flame retardant contained in the mixed liquid agent preferably contains a liquid flame retardant in addition to the above-described solid flame retardant. A liquid flame retardant is a flame retardant that is a liquid at normal temperature and pressure. Specific examples of the liquid flame retardant include a phosphoric acid ester. By containing a liquid flame retardant in the mixed liquid agent, it is easier to improve the flame retardancy of the mixed liquid agent with almost no decrease in the discharge flow rate, miscibility, and the like.

As the phosphoric acid ester, a monophosphoric acid ester, a condensed phosphoric acid ester, or the like can be used. The monophosphoric acid ester is a phosphoric acid ester having one phosphorus atom in the molecule. The monophosphoric acid ester is not limited as long as it is a liquid at normal temperature and pressure, and examples thereof include a trialkyl phosphate such as trimethyl phosphate, triethyl phosphate, tributyl phosphate, and tri(2-ethylhexyl)phosphate, a halogen-containing phosphate such as tris(β-chloropropyl)phosphate, a trialkoxy phosphate such as tributoxyethyl phosphate, an aromatic ring-containing phosphoric acid ester such as tricresyl phosphate, trixylenyl phosphate, tris(isopropylphenyl)phosphate, cresyldiphenyl phosphate, and diphenyl(2-ethylhexyl)phosphate, an acidic phosphoric acid ester such as monoisodecyl phosphate and diisodecyl phosphate, and the like.

Examples of the condensed phosphoric acid ester include an aromatic condensed phosphoric acid ester such as trialkyl polyphosphate, resorcinol polyphenyl phosphate, bisphenol A polycresyl phosphate, and bisphenol A polyphenyl phosphate.

Examples of commercially available condensed phosphoric acid esters include “CR-733S”, “CR-741”, and “CR747”, which are manufactured by Daihachi Chemical Industry Co., Ltd., “Adeka Stub PFR” and “FP-600” manufactured by ADEKA, and the like.

As the liquid flame retardant, one kind of the above-described liquid flame retardants may be used alone, or two or more thereof may be used in combination. Among these, a monophosphoric acid ester is preferable, and a halogen-containing phosphoric acid ester such as tris(β-chloropropyl) phosphate is more preferable from the viewpoint of facilitating an appropriate viscosity of the polyol compound and improving the flame retardancy of the polyurethane foam.

When the mixed liquid agent contains a liquid flame retardant, the amount of the liquid flame retardant blended in the mixed liquid agent is preferably 5 to 70 parts by mass, more preferably 10 to 60 parts by mass, and further preferably 20 to 50 parts by mass, with respect to 100 parts by mass of the polyol compound. By setting the amount of the liquid flame retardant blended to be not less than these lower limit values, the effect gained by containing the liquid flame retardant is more easily exhibited. On the other hand, by setting the amount blended to be not more than these upper limit values, foaming of the polyurethane foam is not inhibited by the liquid flame retardant.

Among the above-described solid flame retardants, it is preferable to use a red phosphorus flame retardant, a bromine-containing flame retardant, and a boron-containing flame retardant, and among them, it is preferable to use a red phosphorus flame retardant. By using a red phosphorus flame retardant, it is easier to further improve the flame retardancy.

Further, as the solid flame retardant, it is also preferable to use a red phosphorus flame retardant in combination with a solid flame retardant other than the red phosphorus flame retardant. In this case, the solid flame retardant other than the red phosphorus flame retardant may be one or more selected from the phosphoric acid salt-containing flame retardant, the bromine-containing flame retardant, the chlorine-containing flame retardant, the antimony-containing flame retardant, the boron-containing flame retardant, and the metal hydroxide, but it is preferably one or more selected from the bromine-containing flame retardant and the boron-containing flame retardant. By using the red phosphorus flame retardant in combination with the bromine-containing flame retardant or the boron-containing flame retardant, it is even easier to further improve the flame retardancy.

In addition, from the viewpoint of flame retardancy, the solid flame retardant used in combination with the red phosphorus flame retardant is more preferably both the bromine-containing flame retardant and the boron-containing flame retardant.

Moreover, in the present invention, as described above, it is also preferable to use the solid flame retardant in combination with the liquid flame retardant. Therefore, as the flame retardant, it is preferable to use at least the red phosphorus flame retardant, which is a solid flame retardant, and the phosphoric acid ester, which is a liquid flame retardant.

From the viewpoint of flame retardancy, in addition to the red phosphorus flame retardant and the phosphoric acid ester, it is preferable to further use one or more selected from the phosphoric acid salt-containing flame retardant, the bromine-containing flame retardant, the chlorine-containing flame retardant, the antimony-containing flame retardant, the boron-containing flame retardant, and the metal hydroxide, and it is more preferable to further use one or more selected from the bromine-containing flame retardant and the boron-containing flame retardant.

Further, it is most preferable to use both the bromine-containing flame retardant and the boron-containing flame retardant in addition to the red phosphorus flame retardant and the phosphoric acid ester.

### (Foam Stabilizing Agent)

The mixed liquid agent of the present invention may contain a foam stabilizing agent. The foam stabilizing agent improves the foaming property of the polyurethane composition obtained from the mixed liquid agent (polyol liquid agent) and the isocyanate liquid agent.

Examples of the foam stabilizing agent include a surfactant such as a polyoxyalkylene-based foam stabilizing agent, for example a polyoxyalkylene alkyl ether, a silicone-based foam stabilizing agent, for example an organopolysiloxane, and the like. These foam stabilizing agents may be used singly or in combination of two or more thereof.

The amount of the foam stabilizing agent blended is preferably 0.1 to 10 parts by mass, more preferably 0.5 to 8 parts by mass, and further preferably 1 to 5 parts by mass, with respect to 100 parts by mass of the polyol compound. When the amount of the foam stabilizing agent blended is equal to or more than these lower limit values, the polyurethane composition composed of the mixed liquid agent and the isocyanate liquid agent can be easily foamed, and a homogeneous polyurethane foam can be easily obtained. Further, when the amount of the foam stabilizing agent blended is equal to or less than these upper limit values, the balance between the production cost and the obtained effect is good.

### (Anti-Sedimentation Agent)

The mixed liquid agent of the present invention may contain an anti-sedimentation agent. By using an anti-sedimentation agent, it is possible to prevent sedimentation of the solid flame retardant dispersed in the mixed liquid agent. In addition, the use of an anti-sedimentation agent facilitates uniform dispersion of the solid flame retardant. The anti-sedimentation agent is generally a solid at normal temperature and pressure, and is usually solid content (insoluble matter) in the mixed liquid agent.

The anti-sedimentation agent is not particularly limited, and it is preferable to use, for example, one or more selected from carbon black, a powdered silica, a hydrogenated castor oil wax, a fatty acid amide wax, an organic clay, and the like. Of these, powdered silica is more preferable.

The carbon black used for the anti-sedimentation agent can be produced by a method such as a furnace method, a channel method, or a thermal method. A commercially available product may also be appropriately selected and used for the carbon black.

Further, as the powdered silica, fumed silica, colloidal silica, silica gel, and the like can be used. Among these, fumed silica is preferable, and hydrophobic fumed silica is particularly preferable. As the fumed silica, Aerosil (registered trademark) manufactured by Nippon Aerosil Co., Ltd., can be used.

The hydrogenated castor oil wax, fatty acid amide wax, and the like form a swollen gel structure in a liquid. These are generally commercially available under names such as a thixotropic agent, a thickening agent, an anti-sedimentation agent, an anti-dripping agent, and the like, and commercially available products can be appropriately selected and used.

The amount of the anti-sedimentation agent blended is not particularly limited, and is, for example, 0.5 to 20 parts by mass, preferably 0.7 to 12 parts by mass, and more preferably 1.1 to 8 parts by mass, with respect to 100 parts by mass of the solid flame retardant. By setting the amount of the anti-sedimentation agent blended to within the above ranges, it is possible to prevent sedimentation of the solid flame retardant and also to improve the dispersing ability of the solid flame retardant, without increasing the solid content more than is necessary.

### (Water)

The mixed liquid agent of the present invention may contain water. The inclusion of water improves the foaming property when forming the polyurethane foam. The amount of water blended is, for example, 0.1 to 10 parts by mass, preferably 0.2 to 5 parts by mass, and more preferably 0.3 to 3 parts by mass, with respect to 100 parts by mass of the polyol compound. By setting the amount of water blended to within these ranges, the polyurethane composition can be easily foamed appropriately.

Further, in addition to water, the mixed liquid agent of the present invention may further contain one or more selected from nitrogen gas, oxygen gas, argon gas, carbon dioxide gas, and the like as a foaming agent.

### (Other Components)

The mixed liquid agent of the present invention may contain components other than the above-described components as long as the effects of the present invention are not impaired. Examples of such components include an inorganic filler other than the above-described anti-sedimentation agent and solid flame retardant.

Examples of the inorganic filler include alumina, titanium oxide, calcium oxide, magnesium oxide, iron oxide, tin oxide, antimony oxide, a ferrite, basic magnesium carbonate, calcium carbonate, magnesium carbonate, zinc carbonate, barium carbonate, dosonite, hydrotalcite, calcium sulfate, barium sulfate, gypsum fiber, calcium silicate, talc, clay, mica, montmorillonite, bentonite, active white clay, sebiolite, imogolite, cericite, glass fiber, glass beads, silica balloon, aluminum nitride, boron nitride, silicon nitride, graphite, carbon fiber, carbon balloon, charcoal powder, various metal powders, potassium titanate, magnesium sulfate, lead zirconate titanate, molybdenum sulfide, silicon carbide, stainless fiber, various magnetic powders, slag fibers, fly ash, silica-alumina fiber, alumina fiber, silica fiber, zirconia fiber, and the like. The inorganic filler is a solid component that is a solid at normal temperature and pressure.

The inorganic filler may be used alone or in combination of two or more.

The mixed liquid agent can optionally include, as long as the object of the present invention is not impaired, an additive such as a phenol-based, amine-based, sulfur-based or other antioxidant, a heat stabilizer, a metal damage inhibitor, an antistatic agent, a stabilizer, a cross-linking agent, a lubricant, a softener, a pigment, and a tackifying resin, a tackifier such as polybutene and a petroleum resin, and the like.

However, in the mixed liquid agent of the present invention, it is desirable not to blend more solid components that are solid at normal temperature and pressure than necessary. It is preferable to reduce the amount of the solid components blended other than the above-described components as much as possible, and the amount blended should be less than the total amount of the solid flame retardant and the anti-sedimentation agent blended. The amount of the solid content of the components blended other than the above-described components (that is, the organic solvent, polyol compound, foam stabilizing agent, catalyst, flame retardant, anti-sedimentation agent, water, and foaming agent) is, for example, 10 parts by mass or less, preferably 5 parts by mass or less, and more preferably 1 part by mass or less, with respect to 100 parts by mass of the polyol compound.

### (Method for Producing Mixed Liquid Agent)

The method for producing the mixed liquid agent of the present invention is not particularly limited. For example, the mixed liquid agent may be produced by mixing each of the components other than the organic solvent as necessary using a disper or the like, then filling the mixture into a container such as a spray can, then filling the organic solvent into the container, and sealing the container.

### [Polyurethane Composition]

The polyurethane composition of the present invention comprises the above-described mixed liquid agent and an isocyanate liquid agent containing a polyisocyanate. That is, the above-described mixed liquid agent of the present invention is used as a polyol liquid agent of a two-component polyurethane, and is used as a polyurethane composition by mixing with an isocyanate liquid agent containing a polyisocyanate. The polyol liquid agent and the isocyanate liquid agent may be mixed in a mass ratio so that an isocyanate index is within a predetermined range, as described later.

The polyurethane composition obtained by mixing the mixed liquid agent and the isocyanate liquid agent reacts with and is caused to foam by the organic solvent contained in the above-described mixed liquid agent, or the organic solvent contained in the isocyanate liquid agent described later, to thereby form a polyurethane foam.

### (Isocyanate Liquid Agent)

As the polyisocyanate used in the isocyanate liquid agent, a known polyisocyanate used for forming polyurethane foam can be used. Examples of the polyisocyanate include an aromatic polyisocyanate, an alicyclic polyisocyanate, an aliphatic polyisocyanate, and the like.

Examples of the aromatic polyisocyanate include phenylene diisocyanate, tolylene diisocyanate, xylylene diisocyanate, diphenylmethane diisocyanate, dimethyldiphenylmethane diisocyanate, triphenylmethane triisocyanate, naphthalene diisocyanate, polymethylene polyphenyl polyisocyanate (polymeric MDI), and the like.

Examples of the alicyclic polyisocyanate include cyclohexylene diisocyanate, methylcyclohexylene diisocyanate, isophorone diisocyanate, dicyclohexylmethane diisocyanate, dimethyldicyclohexylmethane diisocyanate, and the like.

Examples of the aliphatic polyisocyanate include methylene diisocyanate, ethylene diisocyanate, propylene diisocyanate, tetramethylene diisocyanate, hexamethylene diisocyanate, and the like.

Among these, from the viewpoint of ease of use and availability, an aromatic polyisocyanate is preferable, and diphenylmethane diisocyanate, polymeric MDI, or a mixture thereof is more preferable. One kind of polyisocyanate may be used alone, or two or more kinds may be mixed and used.

The isocyanate liquid agent usually further contains an organic solvent. The organic solvent is preferably one or more selected from the above-described hydrocarbons having 2 to 5 carbon atoms, dimethyl ether, and hydrofluoroolefin, but more preferably includes one or more selected from hydrocarbons having 3 or 4 carbon atoms and dimethyl ether.

The organic solvent used for the isocyanate liquid agent may be the same as or different from the organic solvent used for the mixed liquid agent.

The ratio of the organic solvent to be included in the isocyanate liquid agent is preferably 5% by mass or more and less than 20% by mass, and more preferably 7% by mass or more and less than 15% by mass. A sufficient discharge force can be obtained by including 5% by mass or more of the organic solvent. Further, by setting the ratio of the organic solvent to be less than 20% by mass, the obtained foaming density is not too low and appropriate physical properties are obtained.

In addition, the polyisocyanate liquid agent may appropriately contain a known additive that is blended in polyisocyanates.

### <Isocyanate Index>

The polyurethane composition of the present invention has an isocyanate index of preferably 250 or more. When the isocyanate index is 250 or more, the amount of polyisocyanate with respect to the polyol is in excess, so that isocyanurate bonds due to a polyisocyanate trimer tend to form, and as a result the flame retardancy of the polyurethane foam is improved. In order to further improve the flame retardancy, the isocyanate index is more preferably 300 or more, and further preferably 340 or more.

Further, the isocyanate index is preferably 1000 or less, more preferably 650 or less, and further preferably 500 or less. When the isocyanate index is equal to or less than these upper limit values, the balance between the flame retardancy of the obtained polyurethane foam and the production cost is good.

The isocyanate index can be calculated by the following method.

Isocyanate index=equivalent amount of polyisocyanate÷(equivalent amount of polyol+equivalent amount of water)×100

Here, each of the equivalent amounts can be calculated as follows.

Equivalent amount of polyisocyanate=amount of polyisocyanate used (g)×NCO content (% by mass)/molecular weight of NCO (mol)×100

Equivalent amount of polyol=OHV×amount of polyol used (g)÷molecular weight of KOH (mmol)

OHV is the hydroxyl value (mgKOH/g) of the polyol.

Equivalent amount of water=amount of water used (g)/molecular weight of water (mol)×number of OH groups of water

In each of the above formulas, the molecular weight of NCO is 42 (mol), the molecular weight of KOH is 56100 (mmol), the molecular weight of water is 18 (mol), and the number of OH groups of water is 2.

### [Method for Using Mixed Liquid Agent]

The mixed liquid agent of the present invention is used for, for example, an aerosol, and is discharged from a container filled with the mixed liquid agent by the vapor pressure of the organic solvent contained in the mixed liquid agent. Although the mixed liquid agent of the present invention contains a solid flame retardant, by containing an organic solvent having a vapor pressure of a certain value or more as described above, the mixed liquid agent can be discharged at a high discharge flow rate even when the mixed liquid agent is used for an aerosol.

As the container in which the mixed liquid agent is enclosed, a pressure-resistant container is used, and a spray can is preferably used. That is, the present invention also provides a spray can in which a mixed liquid agent is enclosed. As described above, the spray can is for an aerosol. For example, a spray can for an aerosol comprises a container body in which a mixed liquid agent is enclosed and a cap portion for sealing an upper part of the container body. The internal pressure of the container is released by pressing a button or the like provided on the cap portion to open a valve or the like, and the mixed liquid agent is discharged from a discharge port provided in the cap portion by the vapor pressure of the organic solvent.

### (Mixing System)

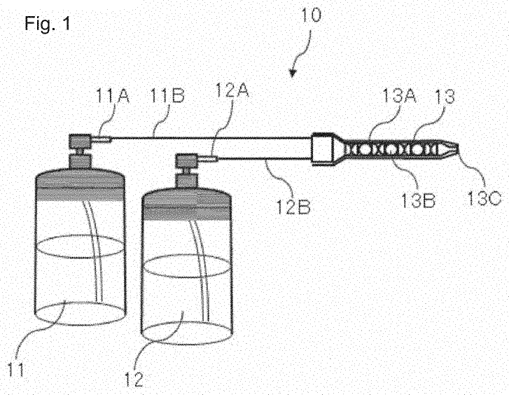

The present invention also provides a mixing system for mixing a mixed liquid agent and an isocyanate liquid agent. As illustrated in FIG. 1, a mixing system 10 comprises a first container 11 in which a mixed liquid agent is enclosed, and a second container 12 in which an isocyanate liquid agent is enclosed. The first and second containers 11 and 12 are both spray cans.

The first and second containers 11 and 12 are spray cans for aerosols, and the mixed liquid agent enclosed in the first container 11 is discharged by the vapor pressure of an organic solvent contained in the mixed liquid agent. The isocyanate liquid agent enclosed in the second container 12 is discharged by the vapor pressure of an organic solvent contained in the isocyanate liquid agent. Inside the first container 11, a part of the organic solvent is vaporized to form a gas phase. The same applies to the inside of the second container 12.

The mixed liquid agent and the isocyanate liquid agent discharged from the first and second containers 11 and 12 are mixed while being foamed by the organic solvents and the like, and the polyisocyanate reacts with the polyol compound to form a polyurethane foam.

The mixing system 10 may include a mixer 13. Discharge ports 11A and 12A of, respectively, the first and second containers 11 and 12, are connected to the mixer 13 via feed lines 11B and 12B. The mixed liquid agent and the isocyanate liquid agent discharged from the first and second containers 11 and 12 are fed to the mixer 13 via the feed lines 11B and 12B, respectively, and are mixed in the mixer 13. The mixed liquid agent and the isocyanate liquid agent mixed in the mixer 13 may be sprayed by an injector or the like onto a surface to be processed.

The mixer 13 is preferably a stationary mixer called a so-called static mixer. The stationary mixer does not have a drive unit, and mixes fluids by passing the fluids through the inside of a pipe. Examples of the stationary mixer include a mixer in which a mixer element 13B is arranged inside a pipe 13A as illustrated in FIG. 1. The mixer element 13B may be formed in a spiral shape or may be formed from a plurality of baffle plates.

The stationary mixer may also include a function of an injector. In that case, as illustrated in FIG. 1, a mixture of the mixed liquid agent and the isocyanate liquid agent mixed inside the pipe 13A may be sprayed from a tip 13C of the pipe.

In the present invention, the polyurethane foam formed from the polyurethane composition can be used for various applications, but it is preferably used as a thermal insulator. Since the polyurethane foam has a large number of cells, it has a thermal insulating effect.

In particular, it is more preferable to use the polyurethane foam as a thermal insulator for a vehicle or a building. The example of vehicle includes rail carriages, automobiles, ships, aircraft, and the like. The polyurethane foam of the present invention has a high flame retardancy due to using of the mixed liquid agent described above. Therefore, from the viewpoint of disaster prevention and safety, the polyurethane foam of the present invention can be suitably used for vehicle or building applications.

The mixed liquid agent of the present invention can form a polyurethane foam with a simple structure by using an aerosol spray can as described above. Further, since an aerosol spray can is used, the mixed liquid agent of the present invention is particularly suitable when the surface to be processed is relatively small. Therefore, for example, it is preferable to use the mixed liquid agent of the present invention for a repair application in which a repair is performed by spraying the mixed liquid agent onto a portion where an existing heat-resistant material has deteriorated or been damaged. Of course, the present invention is not limited to such applications, and may be used for forming a new heat-resistant material.

### EXAMPLES

The present invention will now be described in more detail with reference to examples, but the present invention is not limited thereto.

The methods for measuring the physical properties of the organic solvent and the mixed liquid agent were as follows.

### [Vapor Pressure of Organic Solvent]

The vapor pressure at 20° C. was measured according to a static method. The static method is a method in which a sample is enclosed in a closed container in a vacuum state, the temperature is kept constant, and the equilibrium vapor pressure at that temperature is directly measured using a pressure gauge.

### [Viscosity]

A liquid agent discharged from a spray can containing the mixed liquid agent was placed in an 800 ml or a 1000 ml beaker and stirred on a hot plate at 40° C. for 12 hours at 400 rpm to volatilize the organic solvent. Then, the temperature was returned to room temperature, 300 ml of the mixed liquid agent after the organic solvent had been volatilized was placed in a 300 ml PP (polypropylene) cup, and the value was observed one minute after measuring the viscosity at 1.0 rpm and 25° C. using a B-type viscometer (DV2T, manufactured by Brookfield, spindle LV-3).

### [Solid Content Concentration]

In the same manner as in the viscosity measurement, the organic solvent was volatilized, and then weight of the mixed liquid agent and the weight of a filter paper (Circular quantitative filter paper No. 3, manufactured by Advantech) were measured. The weight of the filter paper was taken as W0, and the total weight of the mixed solvent and the filter paper was taken as W1. The mixed solvent was suction filtered using the filter paper. The residue on the filter paper was washed several times with acetone, and then the filter paper and the residue were allowed to dry for 30 minutes in suction-filtered state. The total weight of the dried filter paper and residue was weighed, and the value was taken as W2. The solid content concentration (% by mass) was calculated by {(W2-W0)/(W1-W0)}×100.

The components used in the examples and comparative examples were as follows. It is also noted that for the components that were diluted, the number of blended parts of each component shown in Table 1 indicates the number of blended parts of each component as the diluted component.
Polyol: Ester-based polyol compound (manufactured by Kawasaki Kasei Chemicals, product name: Maximol RLK-087, hydroxyl value=200 mgKOH/g)
Trimerization catalyst 1: Carboxylic acid quaternary ammonium salt (active ingredient amount 45 to 55% by mass, diluted with ethylene glycol) (Evonik Japan Co., Ltd., product name: DABCO TMR-7)
Trimerization catalyst 2: Potassium carboxylate (active ingredient approximately 75% by mass, diluted with ethanediol, manufactured by Evonik Japan Co., Ltd., product name: DABCO K-15)
Resinification catalyst 1: Carboxylic acid bismuth salt (active ingredient 55 to 58% by mass, diluted with 2-ethylhexanoic acid, manufactured by Nitto Kasei Co., Ltd., product name: Neostann U-600)
Resinification catalyst 2: Imidazole compound (active ingredient amount 65 to 75% by mass, diluted with ethylene glycol, manufactured by Tosoh Corporation, product name: TOYOCAT-DM70)
Liquid flame retardant: Tris(β-chloropropyl)phosphate (manufactured by Daihachi Chemical Co., Ltd., product name: TMCPP)
Solid flame retardant 1: Red phosphorus flame retardant (manufactured by Rinkagaku Kogyo Co., Ltd., product name: Nova Excel 140, coating with metal hydroxide, red phosphorus content 94% by mass or more)
Solid flame retardant 2: Red phosphorus flame retardant (manufactured by Rin Kagaku Kogyo Co., Ltd., product name: Nova Red 120UFA, coating with metal hydroxide, red phosphorus content 90% by mass or more)
Solid flame retardant 3: Zinc borate (manufactured by Hayakawa & Co., Ltd., product name: Firebrake ZB)
Solid flame retardant 4: Ethylene bis(pentabromophenyl) (manufactured by Albemarle, product name: SAYTEX 8010)
Foam stabilizing agent: Polyoxyalkylene-based foam stabilizing agent (manufactured by Dow Corning Toray, product name SH-193)
Anti-sedimentation agent: Fumed silica (manufactured by Aerosil Japan, product name: Aerosil R9765)
Organic solvent 1: Dimethyl ethyl ether (DME)
Organic solvent 2: LBP (mixed gas of butane and propane)
Organic solvent 3: HFO-1233zd (E) (manufactured by Central Glass Co., Ltd., product name: Solstice LBA)

### Example 1

In accordance with the blends shown in Table 1, the components other than the organic solvent were measured into a 1000 ml polypropylene beaker, mixed at 1500 rpm for 5 minutes using a disper, transferred to a spray can, and enclosed using a vacuum crimper. Then, the organic solvent was further filled therein to obtain a first spray can in which a mixed liquid agent was enclosed.

Polyisocyanate (MDI, manufactured by Sumitomo Chemical Co., Ltd., product name: Sumijuru 44V20) was enclosed in another spray can, and organic solvents (mass ratio of organic solvent 1 to organic solvent 2 of 6:4) were further filled therein to obtain a second spray can in which an isocyanate liquid agent was enclosed. In the second spray can, the components were filled so that the mass ratio of the organic solvent to the polyisocyanate was equal to the mass ratio of the organic solvent to the components other than the organic solvent in the first spray can.

Next, the mixing system illustrated in FIG. 1 was prepared. In the mixing system, first and second spray cans prepared as described above were used as the first and second containers, and a static mixer (inner diameter 8 mm, number of elements: 24) was used as the mixer.

The mixed liquid agent and the isocyanate liquid agent were discharged from the first spray can and the second spray can at a mass ratio of 1:1.3 so that the isocyanate index was as shown in Table 1, and the mixture was stirred using a static mixer to obtain a polyurethane composition. The polyurethane composition was sprayed from the tip onto gypsum board to obtain a polyurethane foam.

Next, the gypsum board and the polyurethane foam were cut so that the surface area was 10 cm×10 cm, and the upper part of the polyurethane foam was removed so that the thickness of the polyurethane foam on the gypsum board was 30 mm. The total calorific value when the obtained gypsum board and polyurethane foam were heated for 20 minutes at a radiant heat intensity of 50 kW/m² was measured in accordance with ISO-5660. The results are shown in Table 1.

It is noted that this measurement method is a test method specified by the General Building Research Laboratory, which is the public body stipulated in Article 108-2 of the Building Standards Act Enforcement Ordinances, as conforming to the standard by the cone calorimeter method, and meets the ISO-5660 test method.

Evaluation was carried out according to the following evaluation criteria based on the measured total calorific value.

A: Less than 7 MJ/m²

B: 7 MJ/m² or more and less than 8 MJ/m²

C: 8 MJ/m² or more and less than 10 MJ/m²

D: 10 MJ/m² or more

### Example 2

The same procedure as in Example 1 was carried out, except that the number of blended parts of the solid flame retardant and the anti-sedimentation agent was each 1.2 times that in Example 1, and the number of blended parts of the organic solvent was increased accordingly.

### Example 3

The same procedure as in Example 1 was carried out, except that the number of blended parts of the solid flame retardant and the anti-sedimentation agent was each 0.7 times that in Example 1, the number of blended parts of the organic solvent was decreased accordingly, and the mixed liquid agent and the isocyanate liquid agent were discharged in a mass ratio of 1:1.4.

### Example 4

The same procedure as in Example 1 was carried out, except that the number of blended parts of the solid flame retardant and the anti-sedimentation agent was each 0.5 times that in Example 1, the number of blended parts of the organic solvent was decreased accordingly, and the mixed liquid agent and the isocyanate liquid agent were discharged in a mass ratio of 1:1.5.

### Example 5

The same procedure as in Example 1 was carried out, except that the red phosphorus flame retardant was changed to a flame retardant with a greater amount of metal hydroxide coated thereon.

### Example 6

The same procedure as in Example 1 was carried out, except that the organic solvents used in the mixed liquid agent were a mixed solvent of the organic solvent 1 and the organic solvent 2 in a mass ratio of 6:4.

### Example 7

The same procedure as in Example 1 was carried out, except that the organic solvents used in the mixed liquid agent were a mixed solvent of the organic solvent 1 and the organic solvent 2 in a mass ratio of 8:2.

### Example 8

The same procedure as in Example 1 was carried out, except that the organic solvents used in the mixed liquid agent were a mixed solvent of the organic solvent 1 and the organic solvent 3 in a mass ratio of 6:4.

### Example 9

The same procedure as in Example 1 was carried out, except that the solid flame retardant 3 was left out, the number of blended parts of the solid flame retardant 4 was increased, and the number of blended parts of the organic solvent was adjusted accordingly.

### Example 10

The same procedure as in Example 1 was carried out, except that the solid flame retardant 4 was left out, the number of blended parts of the solid flame retardant 3 was increased, and the number of blended parts of the organic solvent was adjusted accordingly.

### Example 11

The same procedure as in Example 1 was carried out, except that the organic solvent used in the isocyanate liquid agent was changed to the organic solvent 1.

### Example 12

The same procedure as in Example 1 was carried out, except that the discharge ratio was changed to 1:1.17 to set the isocyanate index to 320.

### Example 13

The same procedure as in Example 1 was carried out, except that the discharge ratio was changed to 1:1.9 to set the isocyanate index to 520.

### Comparative Example 1

The same procedure as in Example 1 was carried out, except that the number of blended parts of the solid flame retardant and the anti-sedimentation agent was each 0.45 times that in Example 1, the number of blended parts of the organic solvent was decreased accordingly, and the mixed liquid agent and the isocyanate liquid agent were discharged in a mass ratio of 1:1.5.

### Comparative Example 2

The same procedure as in Example 1 was carried out, except that the used organic solvent was changed to the organic solvent 3.

### Comparative Example 3

The same procedure as in Example 1 was carried out, except that the number of blended parts of the solid flame retardant and the anti-sedimentation agent was each 1.4 times that in Example 1 and the number of blended parts of the organic solvent was increased accordingly.

TABLE 1

| | | Example 1 | Example 2 | Example 3 | Example 4 | Example 5 | Example 6 | Example 7 | Example 8 | Example 9 |
|---|---|---|---|---|---|---|---|---|---|---|
| Mixed | Polyol | 100 | 100 | 100 | 100 | 100 | 100 | 100 | 100 | 100 |
| liquid agent | Trimerization | 7.8 | 7.8 | 7.8 | 7.8 | 7.8 | 7.8 | 7.8 | 7.8 | 7.8 |
| blend (parts | catalyst 1 | | | | | | | | | |
| by mass) | Trimerization | 2.6 | 2.6 | 2.6 | 2.6 | 2.6 | 2.6 | 2.6 | 2.6 | 2.6 |
| | catalyst 2 | | | | | | | | | |
| | Resinification | 2.6 | 2.6 | 2.6 | 2.6 | 2.6 | 2.6 | 2.6 | 2.6 | 2.6 |
| | catalyst 1 | | | | | | | | | |
| | Resinification | 5.2 | 5.2 | 5.2 | 5.2 | 5.2 | 5.2 | 5.2 | 5.2 | 5.2 |
| | catalyst 2 | | | | | | | | | |
| | Water | 0.7 | 0.7 | 0.7 | 0.7 | 0.7 | 0.7 | 0.7 | 0.7 | 0.7 |
| | Liquid flame | 39.1 | 39.1 | 39.1 | 39.1 | 39.1 | 39.1 | 39.1 | 39.1 | 39.1 |
| | retardant | | | | | | | | | |
| | Solid flame | 26.1 | 31.3 | 18.2 | 13.0 | 0.0 | 26.1 | 26.1 | 26.1 | 26.1 |
| | retardant 1 | | | | | | | | | |
| | Solid flame | 0.0 | 0.0 | 0.0 | 0.0 | 26.1 | 0.0 | 0.0 | 0.0 | 0.0 |
| | retardant 2 | | | | | | | | | |
| | Solid flame | 9.8 | 11.7 | 6.8 | 4.9 | 9.8 | 9.8 | 9.8 | 9.8 | 0.0 |
| | retardant 3 | | | | | | | | | |
| | Solid flame | 29.3 | 35.2 | 20.5 | 14.7 | 29.3 | 29.3 | 29.3 | 29.3 | 32.6 |
| | retardant 4 | | | | | | | | | |
| | Foam stabilizing | 2.6 | 2.6 | 2.6 | 2.6 | 2.6 | 2.6 | 2.6 | 2.6 | 2.6 |
| | agent | | | | | | | | | |
| | Anti-sedimentation | 4.9 | 5.9 | 3.4 | 2.4 | 4.9 | 4.9 | 4.9 | 4.9 | 4.9 |
| | agent | | | | | | | | | |
| | Organic solvent 1 | 38.4 | 40.8 | 34.9 | 32.6 | 38.4 | 23.1 | 30.7 | 23.1 | 37.4 |
| | Organic solvent 2 | 0.0 | 0.0 | 0.0 | 0.0 | 0.0 | 15.4 | 7.7 | 0.0 | 0.0 |
| | Organic solvent 3 | 0.0 | 0.0 | 0.0 | 0.0 | 0.0 | 0.0 | 0.0 | 15.4 | 0.0 |
| Total of solid flame retardant | | 65.1 | 78.2 | 45.6 | 32.6 | 65.1 | 65.1 | 65.1 | 65.1 | 58.6 |
| (parts by mass) | | | | | | | | | | |
| Total of organic solvent | | 38.4 | 40.8 | 34.9 | 32.6 | 38.4 | 38.4 | 38.4 | 38.4 | 37.4 |
| (parts by mass) | | | | | | | | | | |
| Liquid/solid flame retardant | | 0.60 | 0.50 | 0.86 | 1.20 | 0.60 | 0.60 | 0.60 | 0.60 | 0.67 |
| (mass ratio) | | | | | | | | | | |
| Isocyanate index | | 356 | 378 | 350 | 350 | 356 | 356 | 356 | 356 | 346 |
| Organic | Vapor pressure | 0.41 | 0.41 | 0.41 | 0.41 | 0.41 | 0.31 | 0.36 | 0.31 | 0.41 |
| solvent | (MPaG 20° C.)) | | | | | | | | | |
| Physical | Solid content | 31.5% | 35.4% | 24.6% | 19.2% | 31.5% | 31.5% | 31.5% | 31.5% | 29.5% |
| properties | concentration | | | | | | | | | |
| of mixed | (% by mass) | | | | | | | | | |
| liquid agent | Viscosity (mPa · s) | 83520 | 230000 | 15960 | 4440 | 104400 | 83520 | 83520 | 83520 | 79400 |
| Flame | Total calorific | 6 | 7.8 | 7.2 | 8.9 | 6.9 | 5.6 | 5.8 | 6.3 | 8.2 |
| retardancy | value (MJ/m²) | | | | | | | | | |
| evaluation | Evaluation result | A | B | B | C | A | A | A | A | C |

| | | | | | | Comparative | Comparative | Comparative |
|---|---|---|---|---|---|---|---|---|
| | | Example 10 | Example 11 | Example 12 | Example 13 | Example 1 | Example 2 | Example 3 |
| Mixed | Polyol | 100 | 100 | 100 | 100 | 100 | 100 | 100 |
| liquid agent | Trimerization | 7.8 | 7.8 | 7.8 | 7.8 | 7.8 | 7.8 | 7.8 |
| blend (parts | catalyst 1 | | | | | | | |
| by mass) | Trimerization | 2.6 | 2.6 | 2.6 | 2.6 | 2.6 | 2.6 | 2.6 |
| | catalyst 2 | | | | | | | |
| | Resinification | 2.6 | 2.6 | 2.6 | 2.6 | 2.6 | 2.6 | 2.6 |
| | catalyst 1 | | | | | | | |
| | Resinification | 5.2 | 5.2 | 5.2 | 5.2 | 5.2 | 5.2 | 5.2 |
| | catalyst 2 | | | | | | | |
| | Water | 0.7 | 0.7 | 0.7 | 0.7 | 0.7 | 0.7 | 0.7 |
| | Liquid flame | 39.1 | 39.1 | 39.1 | 39.1 | 39.1 | 39.1 | 39.1 |
| | retardant | | | | | | | |
| | Solid flame | 26.1 | 26.1 | 26.1 | 26.1 | 11.7 | 26.1 | 36.5 |
| | retardant 1 | | | | | | | |
| | Solid flame | 0.0 | 0.0 | 0.0 | 0.0 | 0.0 | 0.0 | 0.0 |
| | retardant 2 | | | | | | | |
| | Solid flame | 19.5 | 9.8 | 9.8 | 9.8 | 4.4 | 9.8 | 13.7 |
| | retardant 3 | | | | | | | |
| | Solid flame | 0.0 | 29.3 | 29.3 | 29.3 | 13.2 | 29.3 | 41.0 |
| | retardant 4 | | | | | | | |
| | Foam stabilizing | 2.6 | 2.6 | 2.6 | 2.6 | 2.6 | 2.6 | 2.6 |
| | agent | | | | | | | |
| | Anti-sedimentation | 4.9 | 4.9 | 4.9 | 4.9 | 2.0 | 4.9 | 6.8 |
| | agent | | | | | | | |
| | Organic solvent 1 | 35.2 | 38.4 | 38.4 | 38.4 | 32.0 | 0.0 | 43.1 |
| | Organic solvent 2 | 0.0 | 0.0 | 0.0 | 0.0 | 0.0 | 0.0 | 0.0 |
| | Organic solvent 3 | 0.0 | 0.0 | 0.0 | 0.0 | 0.0 | 38.4 | 0.0 |
| Total of solid flame retardant | | 45.6 | 65.1 | 65.1 | 65.1 | 29.3 | 65.1 | 91.2 |
| (parts by mass) | | | | | | | | |
| Total of organic solvent | | 35.2 | 38.4 | 38.4 | 38.4 | 32.0 | 38.4 | 43.1 |
| (parts by mass) | | | | | | | | |
| Liquid/solid flame retardant | | 0.86 | 0.60 | 0.60 | 0.60 | 1.33 | 0.60 | 0.43 |
| (mass ratio) | | | | | | | | |
| Isocyanate index | | 326 | 356 | 320 | 520 | 347 | 356 | 397 |
| Organic | Vapor pressure | 0.41 | 0.41 | 0.41 | 0.41 | 0.41 | 0.005 | 0.41 |
| solvent | (MPaG 20° C.)) | | | | | | | |
| Physical | Solid content | 25.2% | 31.5% | 30.4% | 30.4% | 17.7% | 31.5% | 38.9% |
| properties | concentration | | | | | | | |
| of mixed | (% by mass) | | | | | | | |
| liquid agent | Viscosity (mPa · s) | 76200 | 83520 | 83520 | 83520 | 3900 | 83520 | 410000 |
| Flame | Total calorific | 8.5 | 6.6 | 7.5 | 7.9 | 10.8 | 10.1 | 12 |
| retardancy | value (MJ/m²) | | | | | | | |
| evaluation | Evaluation result | C | A | B | B | D | D | D |

In the above examples, polyurethane foams were formed using a mixed liquid agent containing a polyol compound, a catalyst, a flame retardant, and an organic solvent. In that case, by blending a solid flame retardant as a flame retardant, setting the vapor pressure at 20° C. of the organic solvent to 0.1 MPaG or more, and setting the viscosity at 1 rpm and 25° C. after volatilizing the organic solvent to 4,000 mPa·s or more and less than 250,000 mPa·s, the flame retardancy of the polyurethane foams was excellent.

### REFERENCE SIGNS LIST

10 mixing system
11 first container
12 second container
11A, 12A discharge port
11B, 12B feed line
13 mixer
13A pipe
13B mixer element
13C tip

1. A mixed liquid agent comprising a polyol compound, a catalyst, a flame retardant, and an organic solvent,
the flame retardant including a solid flame retardant,
the organic solvent having a vapor pressure at 20° C. of 0.1 MPaG or more,
a viscosity of the mixed liquid agent at 1 rpm and 25° C. after the organic solvent has been volatilized being 4,000 mPa·s or more and less than 250,000 mPa·s.

2. The mixed liquid agent according to claim 1, wherein the viscosity is 10,000 mPa·s or more.

3. The mixed liquid agent according to claim 1, wherein the solid flame retardant is at least one selected from the group consisting of a red phosphorus flame retardant, a phosphoric acid salt-containing flame retardant, a bromine-containing flame retardant, a chlorine-containing flame retardant, an antimony-containing flame retardant, a boron-containing flame retardant, and a metal hydroxide.

4. The mixed liquid agent according to claim 1, wherein a solid content concentration after the organic solvent has been volatilized is 15 to 40% by mass.

5. The mixed liquid agent according to claim 1, wherein the flame retardant further includes a liquid flame retardant.

6. The mixed liquid agent according to claim 1, wherein the organic solvent includes at least one selected from the group consisting of a hydrocarbon having 2 to 5 carbon atoms and dimethyl ether.

7. The mixed liquid agent according to claim 1, wherein the mixed liquid agent further comprises a foam stabilizing agent.

8. The mixed liquid agent according to claim 1, wherein the mixed liquid agent is used for an aerosol.

9. A spray can in which the mixed liquid agent according to claim 1 is enclosed.

10. A polyurethane composition comprising the mixed liquid agent according to claim 1 and an isocyanate liquid agent containing a polyisocyanate.

11. The polyurethane composition according to claim 10, wherein the polyurethane composition has an isocyanate index of 250 to 1000.

12. A polyurethane foam formed from the polyurethane composition according to claim 10.

13. The polyurethane foam according to claim 12, wherein the polyurethane foam is used as a thermal insulator for a vehicle or a building.

14. A mixing system comprising a first container in which the mixed liquid agent according to claim 1 is enclosed and a second container in which an isocyanate liquid agent containing a polyisocyanate is enclosed,
the first and second containers being both spray cans,
the mixing system being configured to mix the mixed liquid agent discharged from the first container and the isocyanate liquid agent discharged from the second container.

15. The mixing system according to claim 14, comprising a stationary mixer being configured to mix the mixed liquid agent discharged from the first container and the isocyanate liquid agent discharged from the second container.
